(19) United States
(12) Patent Application Publication
(10) Pub. No.: US 2026/0070079 A1
(43) Pub. Date: Mar. 12, 2026

(54) Apparatus and Method for Applying Liquid to a Free End of a Small Diameter Component

(71) Applicant: Becton, Dickinson and Company, Franklin Lakes, NJ (US)

(72) Inventor: Glenn Richard VanSickle, Hewitt, NJ (US)

(21) Appl. No.: 19/319,937

(22) Filed: Sep. 5, 2025

Related U.S. Application Data
(60) Provisional application No. 63/693,333, filed on Sep. 11, 2024.

(51) Int. Cl. B05C 5/02; B05C 11/02; B05C 11/06; B05C 11/10

(52) U.S. Cl. CPC B05C 5/0212; B05C 11/021; B05C 11/06; B05C 11/1039

(57) ABSTRACT

An apparatus for applying an adhesive to tubing end includes an adhesive supply, a vacuum source, and a tube holding block. The tube holding block includes a tube holding channel including a tip holding portion and channel end, an adhesive flow path that receives and communicates adhesive to the tip holding portion, a first air inflow channel, a second air inflow channel, and a vacuum flow path that communicates a vacuum to the tip holding portion to create a negative pressure therein. The negative pressure draws air into the tube holding block through the first air inflow channel, with the air mixing with the adhesive to inject an air-adhesive mixture into the tip holding portion that coats the end section with adhesive. The negative pressure also draws air into the tube holding block through the second air inflow channel to prevent adhesive from entering an opening at the tubing end.

### CROSS-REFERENCE TO RELATED APPLICATION

The present application claims priority to U.S. Provisional Patent Application No. 63/693,333, entitled “Apparatus and Method for Applying Liquid to a Free End of a Small Diameter Component”, filed Sep. 11, 2024, the entire disclosure of which is hereby incorporated by reference.

### BACKGROUND OF THE INVENTION

### Field of the Disclosure

The present disclosure relates generally to small diameter components such as medical tubing, and more particularly relates to an apparatus and method for applying a liquid to an end section of the outer surface of such components.

### Description of the Related Art

In many industries, manufacturing processes may include a process of applying a liquid coating to an outer surface of a component. For example, a liquid lubricant may be applied to a component or a liquid adhesive may be applied to a component, with the adhesive being used for purposes of subsequently affixing that component to another component.

As a primary example, many medical procedures employ a length of flexible plastic tubing for delivering fluid to a patient or for withdrawing bodily fluids from a patient. Opposed ends of the tubing typically are placed permanently in communication with plastic fittings. The typical plastic fitting includes opposed proximal and distal ends and a passage extending between the ends. Portions of the passage adjacent the proximal end of the fitting are dimensioned to receive an end of the flexible plastic tubing. The distal end of the plastic fitting may be configured for placement directly in communication with a patient or for placement in communication with another fitting.

The connection between the end of the plastic tubing and the proximal end of the plastic fitting must prevent separation of the tubing from the fitting in response to pulling forces and also must achieve a fluid-tight hermetic seal. An adhesive typically has been employed for this one longitudinal side of the plastic tubing adjacent the end of the tubing. To this end, systems and methods have been devised for coating an end of the plastic tubing with adhesive, with the adhesive-coated tube end then inserted into and mated with the plastic fitting to form a secure connection therebetween.

An example of a system for coating an end of a plastic tubing with adhesive is a benchtop adhesive dispenser such as described in U.S. Pat. No. 6,802,903 assigned to Becton Dickinson and Co. The adhesive dispenser therein includes holder portions for retaining the tubing and an adhesive dispenser that injects adhesive under pressure through channels formed in the holder portions for application to a desired area (e.g., near the distal or proximal end) of the tubing to provide a coating thereon. While such benchtop adhesive dispensers are effective in coating the tubing with adhesive, it is recognized that there are some limitations/drawbacks associated with such dispensers due to the structure of the holder portions and/or the manner in which adhesive is applied to the tubing. As one example, a benchtop adhesive dispenser as described above applies adhesive to the tubing in a pressurized manner, thereby exposing the tubing to a “flood” of adhesive. This flood-type application of adhesive coating to the tubing results limits the application process in several respects. First, benchtop adhesive dispensers that utilize a flood-type application of adhesive coating may not be able to accommodate smaller diameter tubing (e.g., <2 mm in diameter), as a flood-type application of the adhesive coating to such smaller diameter tubing may result in adhesive application that blocks/clogs a distal/proximal opening of the tubing. Second, a flood-type application of the adhesive coating restricts application of adhesive all the way out to the distal/proximal end of the tubing, as there is no protection/isolation for the free end of the tubing, such that applying adhesive too close to the free end may again result in adhesive occluding the distal/proximal opening of the tubing.

Accordingly, a need exists for an apparatus and method for coating an end of a plastic tubing with adhesive. The apparatus and method should be designed to be able to handle tubing smaller than the current industry minimum outer diameter sizes without occluding the free end of the tube and should be designed to precisely control the flow of the adhesive away from the free end of the tubing.

### SUMMARY OF THE INVENTION

Provided herein is an apparatus for applying an adhesive to an outer circumferential surface of an end section of tubing. The apparatus includes an adhesive supply configured to provide an adhesive, a vacuum source configured to generate a vacuum, and a tube holding block in fluid communication with each of the adhesive supply and the vacuum source. The tube holding block comprises a tube holding channel including a tip holding portion and a channel end, with the tip holding portion and channel end retaining the end section of the tubing therein. The tube holding block also comprises an adhesive flow path fluidly connected to the adhesive supply to receive adhesive therefrom and communicate adhesive to the tip holding portion through an adhesive opening formed in the tip holding portion, a first air inflow channel extending between an exterior surface of the tube holding block and the adhesive flow path, and a vacuum flow path fluidly connected to the vacuum source to communicate a vacuum to the tip holding portion through a vacuum opening formed in the tip holding portion, so as to create a negative pressure within the tip holding portion. The negative pressure within the tip holding portion draws air into the tube holding block through the first air inflow channel, with the air mixing with the adhesive in the adhesive flow path to inject an air-adhesive mixture into the tip holding portion that coats the end section with adhesive. A portion of the air-adhesive mixture, including excess adhesive that does not coat the end section, is drawn out of the tip holding portion through the vacuum opening.

In some embodiments, the tube holding block comprises an adhesive block portion and a vacuum block portion, wherein each of the adhesive block portion and the vacuum block portion includes a mirrored portion of the tube holding channel, with the mirrored portions joining together to form the tube holding channel, and wherein the adhesive block portion includes the adhesive flow path and the first air inflow channel therein and the vacuum block portion includes the vacuum flow path.

In some embodiments, the apparatus further includes an actuator assembly configured to move at least one of the adhesive block portion and the vacuum block portion, to bring the adhesive block portion and the vacuum block portion from a load position where the adhesive block portion is separated from the vacuum block portion to a dispense position where the adhesive block portion is joined with the vacuum block portion.

In some embodiments, the vacuum block portion comprises engagement apertures formed therein via which the vacuum block portion is mounted to the actuator assembly.

In some embodiments, the tube holding block comprises a second air inflow channel extending between an exterior surface of the tube holding block and the channel end, with each of the adhesive block portion and the vacuum block portion including a mirrored portion of the second air inflow channel and with the mirrored portions joining together to form second air inflow channel, and wherein the negative pressure within the tip holding portion draws air into the tube holding block through the second air inflow channel.

In some embodiments, the air drawn into the tube holding block through the second air inflow channel prevents adhesive from entering into an opening formed in the end section of the tubing, by diverting the air-adhesive mixture away from the opening.

In some embodiments, the first air inflow channel extends between a front surface of the tube holding block and the adhesive flow path and the second air inflow channel extends between the front surface of the tube holding block and the channel end.

In some embodiments, the channel end comprises a conical channel end, the conical channel end tapering from a first diameter at an end thereof joined to the tip holding portion to a second diameter at an end thereof joined to the second air inflow channel, with the first diameter larger than a diameter of the tubing and the second diameter smaller than the diameter of the tubing.

In some embodiments, the conical channel end is configured such that with end section of the tubing retained in the tip holding portion and conical channel end, the conical channel end forms a seal with an opening of the end section, so as to prevent adhesive from entering into the opening.

In some embodiments, the vacuum block portion includes a protrusion configured to engage a cavity formed in the adhesive block portion, to secure the adhesive block portion with the vacuum block portion when in the dispense position.

In some embodiments, the vacuum opening and the adhesive opening are formed on generally opposing sides of the tip holding portion, such that the air-adhesive mixture injected into the tip holding portion through the adhesive opening flows over and about the end section before exiting the tip holding portion through the vacuum opening.

In some embodiments, a diameter of the tip holding portion is larger than a rear portion of the tube holding channel and larger than the end section of the tubing, such that a gap is present between walls of the tip holding portion and the end section.

In some embodiments, a rear surface of the tube holding block comprises a funnel-shaped receptacle that forms a transition between the rear face and the tube holding channel.

In some embodiments, the tube holding channel extends from a rear surface of the tube holding block to a location between the rear surface and a front surface of the tube holding block, such that the tube holding channel extends only partially through a length of the tube holding block.

Also provided herein is a method for applying adhesive to an outer circumferential surface of an end section of tubing having an opening therein. The method includes positioning a portion of the tubing into a tube holding channel of a tube holding block, including positioning the end section of the tubing into a tip holding portion and channel end of the tube holding channel, and creating a negative pressure condition in the tip holding portion via a vacuum source, the vacuum source in fluid communication with the tip holding portion through a vacuum flow path formed in the tube holding block. The method also includes providing a liquid adhesive to the tip holding portion via an adhesive supply, the adhesive supply in fluid communication with the tip holding portion through an adhesive flow path formed in the tube holding block. The method further includes drawing an airflow into the tip holding portion via a first air intake channel formed in the tube holding block, with the airflow drawn into the first air intake channel responsive to the negative pressure. The first air intake channel is joined to the adhesive flow path, such that the airflow mixes with the liquid adhesive to form an air-adhesive mixture that flows into the tip holding portion to coat the outer circumferential surface of the end section of the tubing. A portion of the air-adhesive mixture, including excess adhesive that does not coat the end section, is drawn out of the tip holding portion through the vacuum flow path.

In some embodiments, the method further includes drawing an airflow into the tip holding portion through the channel end via a second air intake channel formed in the tube holding block, with the airflow drawn into the second air intake channel responsive to the negative pressure.

In some embodiments, the airflow drawn into the tube holding block through the second air inflow channel prevents adhesive from entering into the opening in the end section of the tubing, by diverting the air-adhesive mixture away from the opening.

In some embodiments, positioning the end section of the tubing into the tip holding portion and channel end comprises engaging the end section with the channel end such that the opening of the end section forms a seal with the channel end, so as to prevent adhesive from entering into the opening.

In some embodiments, the air-adhesive mixture that flows into the tip holding portion flows through an adhesive opening formed on a first side of the tip holding portion and the air-adhesive mixture is drawn out of the tip holding portion through a vacuum opening formed on a second side of the tip holding portion that is generally opposite the first side, such that the air-adhesive mixture that flows into the tip holding portion through the adhesive opening flows over and about the end section before exiting the tip holding portion through the vacuum opening.

In some embodiments, the tube holding block comprises an adhesive block portion and a vacuum block portion, and the method further includes operating an actuator assembly to move at least one of the adhesive block portion and the vacuum block portion, to bring the adhesive block portion and the vacuum block portion from a load position where the adhesive block portion is separated from the vacuum block portion to a dispense position where the adhesive block portion is joined with the vacuum block portion.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a schematic view of an adhesive applicator apparatus in accordance with an aspect of the disclosure, with a tube holding block of the adhesive applicator apparatus in a load position that permits loading of a section of tubing;

FIG. 2 illustrates the adhesive applicator apparatus of FIG. 1 with the tube holding block in a dispense position that permits application of adhesive to an end section of the tubing;

FIG. 3 is a perspective view of an adhesive block portion and a vacuum block portion of the tube holding block of FIG. 1, in accordance with an aspect of the disclosure;

FIG. 4 is a perspective view of the adhesive block portion of FIG. 3, showing internal features of the adhesive block portion;

FIG. 5 is a perspective view of the vacuum block portion of FIG. 3, showing internal features of the vacuum block portion;

FIG. 6 is a cross-sectional view of the tube holding block of FIG. 2 in the dispense position, and illustrating airflow and adhesive flow through the tube holding block;

FIG. 7 is an exploded cross-sectional view showing the tubing with the adhesive applied to the end section thereof and in proximity to a plastic fitting; and

FIG. 8 is a cross-sectional view of the tubing fully mounted in the fitting.

### DETAILED DESCRIPTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present disclosure is directed to an apparatus and method for applying a liquid to an end section of the outer surface of a small diameter component. While the illustrative embodiment described below is directed to application of a liquid adhesive to the end of a length of tubing, it is recognized that the apparatus and method of the present disclosure could be employed to apply any of a number of other liquids (e.g., lubricants) to the outer surface of other components, and thus the scope of the disclosure is not to be limited to the specific examples described in detail herein.

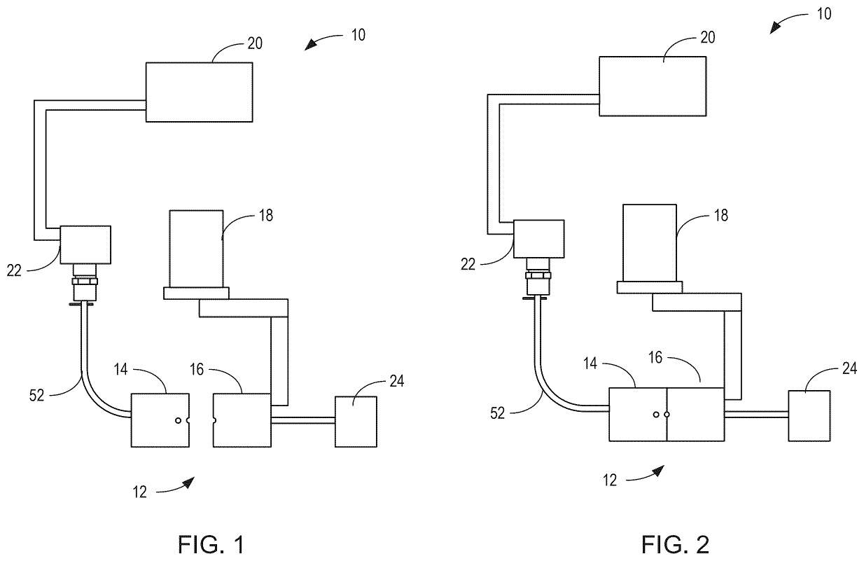

Referring initially to FIGS. 1 and 2, an apparatus for applying adhesive to an outer circumferential surface of a short section of plastic tubing is illustrated. Apparatus 10 includes a tube holding block 12 that may be machined from stainless-steel or another suitable material. The tube holding block 12 may be formed or two separate halves or portions—including a first holder portion 14 and a second holder portion 16 respectively. One or more of holder portions 14 and 16 are mounted to an actuator assembly 18 (e.g., a pneumatic actuator cylinder assembly, for example), which is operative for moving holder portions 14 and 16 from a load position as shown in FIG. 1 to a dispense position as shown in FIG. 2. Holder portions 14 and 16 are spaced from one another in the load position, as shown in FIG. 1, but are brough into contact with one another in the dispense position, as shown in FIG. 2. In the illustrated embodiment, second holder portion 16 is shown mounted to actuator assembly 18 and is caused to move thereby, while holder portion 14 remains stationary, but it is recognized that alternatively both first and second holder portions 14 and 16 could be mounted to actuator assembly 18 and moved thereby or that only first holder portion 14 could be mounted to actuator assembly 18 and moved thereby.

Apparatus 10 further includes an adhesive supply 20 that communicates with a valve 22. The adhesive supply 20 may supply/provide a low viscosity, highly flowable adhesive for application to the tubing. That is, a suitable adhesive may comprise a light-cured acrylic adhesive commonly used in medical device manufacturing with a viscosity in the range of about 300 cP. The valve 22 communicates with first holder portion 14 and is operative for selectively directing a liquid adhesive from adhesive supply 20 to the first holder portion 14. Based on the fluid connection of adhesive supply 20 with the first holder portion 14, the first holder portion 14 may be considered an “adhesive block portion” of the tube holding block 12 and is thus referred to hereafter as “adhesive block portion 14.”Apparatus 10 further includes a vacuum source 24 that communicates with second holder portion 16. The vacuum source 24 is operable to create a negative pressure condition within the tube holding block 12 when the holder portions 14 and 16 are in the dispense position, as explained in further detail below. Based on the fluid connection of vacuum source 24 with the second holder portion 16, the second holder portion 16 may be considered a “vacuum block portion” of the tube holding block 12 and is thus referred to hereafter as “vacuum block portion 16.”

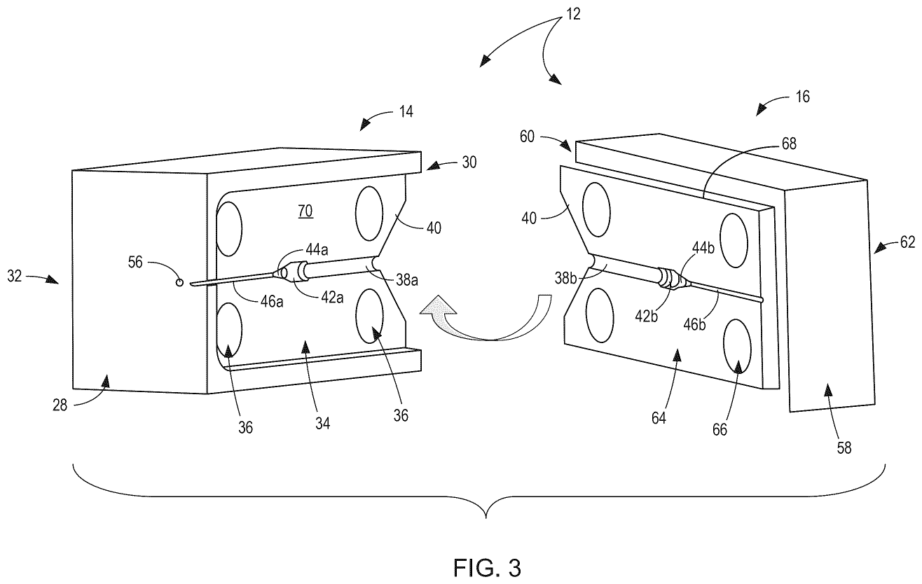

Referring now to FIGS. 3-5, the structure of the adhesive block portion 14 and vacuum block portion 16 of tube holding block 12 are shown in greater detail.

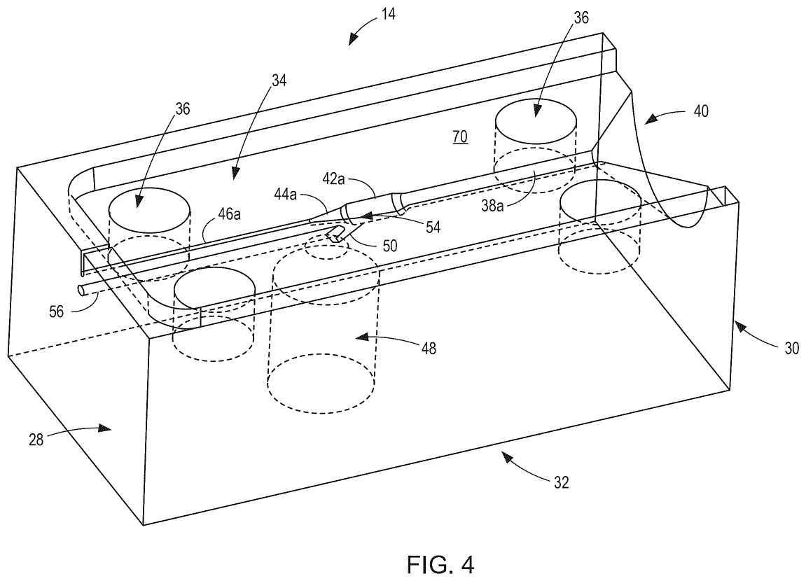

As shown in FIGS. 3 and 4, adhesive block portion 14 includes opposite substantially parallel planar front and rear faces 28 and 30, as well as an adhesive supply face 32 and an opposed tube mating face 34 that extend between the front and rear faces 28 and 30. Adhesive block portion 14 also includes a plurality of engagement apertures 36 that provide for proper alignment and engaging of adhesive block portion 14 with vacuum block portion 16 when the vacuum block portion 16 is moved to the dispense position. The engagement apertures 36 are formed in the tube mating face 34 and may be circular in shape—with the engagement apertures 36 extending from the tube mating face 34 and toward the adhesive supply face 32, so as to have a cylindrical construction.

A tube holding channel 38a (more specifically, a portion of an overall tube holding channel 38 of tube holding block 12) is formed in the tube mating face 34 that extends from the rear face 30 toward the front face 28. The tube holding channel 38a is configured to receive a length of tubing therein, so as to enable application of an adhesive thereto during processing. The tube holding channel 38a has a diameter that is approximately equal to or slightly larger than a diameter of the tubing, such that the tubing may be retained in position within the tube holding channel 38a. At a rear end of the tube holding channel 38a, a funnel-shaped receptacle 40 is formed in the adhesive block portion 14, with the funnel-shaped receptacle 40 forming a transition between the rear face 30 and the tube holding channel 38a and aiding in the positioning/placement of tubing into the tube holding channel 38a.

The tube holding channel 38a includes a tip holding portion 42a and a conical channel end 44a (more specifically, a portion of an overall tip holding portion 42 and a conical channel end 44 of tube holding block 12) at the front end/portion thereof. The tip holding portion 42a is configured and positioned to receive an end of the tubing therein and provide for application of a liquid adhesive thereto during processing. The tip holding portion 42a has a diameter that is larger than a remainder of the tube holding channel 38a, with the tip holding portion 42a sized such that a gap is present between the walls of the tip holding portion 42a and the outer surface of the tubing - thereby allowing for adhesive to flow about the tubing and be applied about an entire circumference thereof, as explained in further detail below. The conical channel end 44a is positioned at a front end of the tip holding portion 42a (i.e., toward front face 28), with the conical channel narrowing in diameter from rear to front. As the conical channel end 44a narrows from rear to front, the diameter thereof transitions from being larger than a diameter of tubing to being smaller than a diameter of tubing. Thus, with the tubing retained within tube holding channel 38a and fully inserted into the tube holding channel 38a for adhesive application, the end of tubing may abut (or nearly abut) the conical channel end 44a and be in contact therewith. In some embodiments, where positioning of the tubing within tube holding block 12 is ideal, the tip of tubing abuts the conical channel end 44a and is sealed thereby such that an opening at the tubing tip is blocked and adhesive is prevented from entering into the opening during application to the tubing. In other embodiments, where positioning of the tubing within tube holding block 12 is not ideal, the tip of tubing may be slightly separated from the conical channel end 44a.

Also included in adhesive block portion 14 are a first air inflow channel 56 and a second air inflow channel 46a.

The second air inflow channel 46a (more specifically, a portion of an overall air inflow channel 46 of tube holding block 12) extends between the conical channel end 44a and the front face 28 of the adhesive block portion 14, with the second air inflow channel 46a providing a fluid connection between the ambient environment and the tube holding channel 38a (i.e., with the tip holding portion 42a). The second air inflow channel 46a has a diameter smaller than tubing, such that tubing is prevented from entering into the air inflow channel.

As best shown in FIG. 4, adhesive block portion 14 further includes an adhesive chamber 48 and an adhesive flow path 50 formed therein. The adhesive chamber 48 is open to the adhesive supply face 32 of the adhesive block portion 14. In some embodiments, the adhesive chamber 48 may be sized and configured to receive and retain the adhesive supply 20 therein, while in other embodiments, the adhesive chamber 48 may provide a conduit through the adhesive block portion 14 for adhesive provided by a remote adhesive supply 20 that is transferred to adhesive chamber 48 through valve 22 and adhesive supply tubing 52 (FIG. 1), with adhesive chamber 48 being fluidly connected to adhesive supply tubing 52. The adhesive flow path 50 connects the adhesive chamber 48 to the tip holding portion 42a of tube holding channel 38a through an adhesive opening 54. With the adhesive flow path 50 and adhesive opening 54 positioned as such, adhesive may be dispensed into the tip holding portion 42a and at a location that is adjacent to a tip/end of the tubing when the tubing is retained within the tube holding block 12.

The first air inflow channel 56 of adhesive block portion 14 is formed at a location between the adhesive supply face 32 and the tube mating face 34. The first air inflow channel 56 fluidly connects to the adhesive flow path 50 and extends from the adhesive flow path 50 to the front face 28 of the adhesive block portion 14. With the first air inflow channel 56 positioned as such, an airflow provided in through the first air inflow channel 56 may be mixed with adhesive as the adhesive is provided into the adhesive flow path 50 (from adhesive chamber 48 and adhesive supply 20), to provide an air-adhesive mixture that is emitted into the tip holding portion 42a.

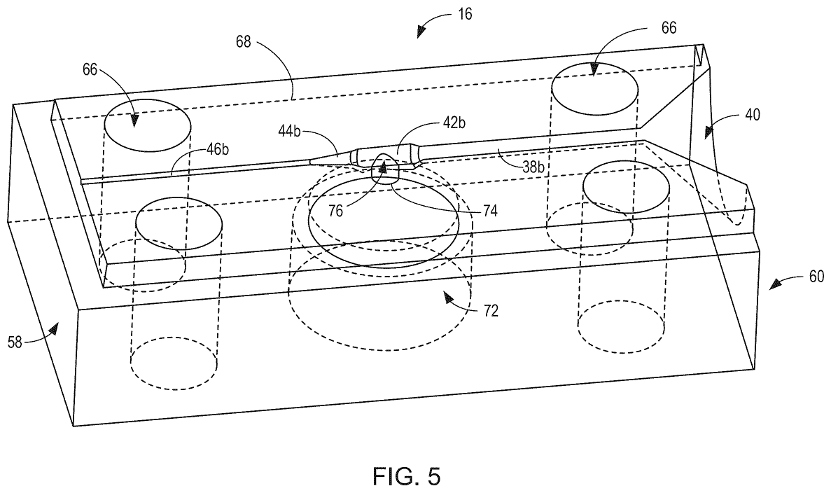

Referring now to FIGS. 3 and 5, the vacuum block portion 16 is shown in greater detail. The vacuum block portion 16 is structurally similar to adhesive block portion 14 and includes substantially parallel planar front and rear faces 58 and 60, along with a vacuum supply face 62 and a tube mating face 64 that extend between the front and rear faces 58 and 60. A plurality of engagement apertures 66 are formed in the vacuum block portion 16 that extend therethrough from the vacuum supply face 62 to the tube mating face 64, with the engagement apertures aligned with the engagement apertures 36 formed in adhesive block portion 14. The engagement apertures 66 function to mount vacuum block portion 16 securely on the actuator assembly 18 and provide for proper alignment and engaging of adhesive block portion 14 with vacuum block portion 16 when the vacuum block portion 16 is moved to the dispense position. In some embodiments, the tube mating face 64 may further include a protrusion 68 extending out therefrom configured to fit within a corresponding cavity 70 formed in the tube mating face 34 of the adhesive block portion 14, so as to further ensure a tight fit/engagement between the vacuum block portion 16 and the adhesive block portion 14.

Similar to adhesive block portion 14, vacuum block portion 16 includes a tube holding channel 38b (more specifically, a mirrored portion of an overall tube holding channel 38 of tube holding block 12, that is joined with tube holding channel 38a, to form channel 38) that is formed in the tube mating face 64 that extends from the rear face 60 toward the front face 58, with the tube holding channel 38b formed at a location to register with tube holding channel 38a of adhesive block portion 14 and form a collective tube holding channel 38 in tube holding block 12 when the holder portions 14 and 16 are moved from the load position shown (FIG. 1) to the dispense position in (FIG. 2). As previously described, the tube holding channel 38b is configured to receive a length of tubing therein, so as to enable application of an adhesive thereof during processing. The tube holding channel 38b has a diameter that is approximately equal to or slightly larger than a diameter of the tubing, such that the tubing may be retained in position within the tube holding channel 38b. At the rear end of the tube holding channel 38b, a funnel-shaped receptacle 40 is formed in the adhesive block portion 14, with the funnel-shaped receptacle 40 forming a transition between the rear face 60 and the tube holding channel 38b and aiding in the positioning/placement of tubing into the tube holding channel 38b.

The tube holding channel 38b includes a tip holding portion 42b and a conical channel end 44b (more specifically, a mirrored portion of an overall tip holding portion 42 and a conical channel end 44 of tube holding block 12) at the front end/portion thereof, with the tip holding portion 42b and a conical channel end 44b formed at a location to register with tip holding portion 42a and a conical channel end 44a of adhesive block portion 14 and form a collective tip holding portion 42 and a conical channel end 44 in tube holding block 12 when the holder portions 14 and 16 are moved from the load position shown (FIG. 1) to the dispense position in (FIG. 2). The tip holding portion 42b is configured and positioned to receive an end of the tubing therein and provide for application of a liquid adhesive thereto during processing. The tip holding portion 42b has a diameter that is larger than a remainder of the tube holding channel 38b, with the tip holding portion 42b sized such that a gap is present between the walls of the tip holding portion 42b and the outer surface of the tubing—thereby allowing for adhesive to flow about the tubing and be applied about an entire circumference thereof. The conical channel end 44b is positioned at the front end of the tip holding portion 42b (i.e., toward front face 58), with the conical channel narrowing in diameter from rear to front. As the conical channel end 44b narrows from rear to front, the diameter thereof transitions from being larger than a diameter of tubing to being smaller than a diameter of tubing. Thus, with the tubing retained within tube holding channel 38b and fully inserted into the tube holding channel 38b for adhesive application, the end of tubing may abut (or nearly abut) the conical channel end 44b and be in contact therewith. In some embodiments, where positioning of the tubing within tube holding block 12 is ideal, the tip of tubing abuts the conical channel end 44b and is sealed thereby such that an opening at the tubing tip is blocked and adhesive is prevented from entering into the opening during application to the tubing. In other embodiments, where positioning of the tubing within tube holding block 12 is not ideal, the tip of tubing may be slightly separated from the conical channel end 44b.

Also included in vacuum block portion 16 is a second air inflow channel 46b (more specifically, a mirrored portion of an overall air inflow channel 46 of tube holding block 12) that extends between the conical channel end 44b and the front face of the vacuum block portion 16, with the second air inflow channel 46b formed at a location to register with second air inflow channel 46a of adhesive block portion 14 and form a collective second air inflow channel 46 in tube holding block 12 when the holder portions 14 and 16 are moved from the load position shown (FIG. 1) to the dispense position in (FIG. 2). The second air inflow channel 46b provides a fluid connection between the ambient environment and the tube holding channel 38b (i.e., with the tip holding portion 42b). The second air inflow channel 46b has a diameter smaller than tubing, such that tubing is prevented from entering into the air inflow channel.

As best shown in FIG. 5, vacuum block portion 16 further includes a vacuum chamber 72 and a vacuum flow path 74 formed therein. The vacuum chamber 72 is open to the vacuum supply face 62 of the vacuum block portion 16. In some embodiments, the vacuum chamber 72 may be sized and configured to receive and retain the vacuum source 24 therein, while in other embodiments, the vacuum chamber 72 may provide a conduit through the vacuum block portion 16 in communication a remote vacuum source 24. The vacuum flow path 74 connects the vacuum chamber 72 to the tip holding portion 42b of tube holding channel 38b through a vacuum opening 76. With the vacuum flow path 74 and vacuum opening 76 positioned as such, a vacuum generated by vacuum source 24 may be communicated with the tip holding portion 42b and at a location that is adjacent to a tip/end of the tubing when the tubing is retained within the tube holding block 12, so as to create a negative pressure condition within the tip holding portion 42b. The opening of the vacuum flow path 74 may be located within tip holding portion 42b so as to be generally opposite the adhesive opening 54 of the adhesive flow path 50.

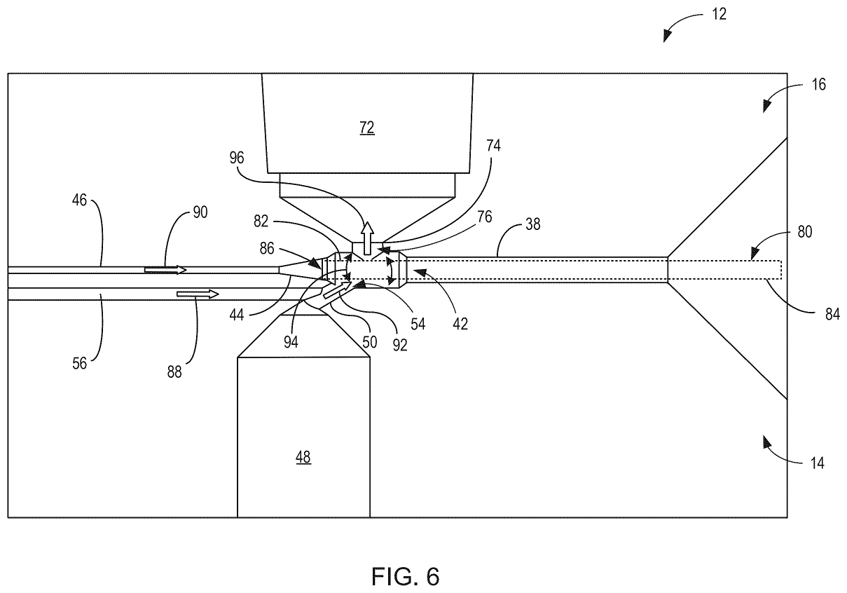

Referring now to FIG. 6, and with continued reference to FIGS. 1-5, operation of the apparatus 10 is described in more detail.

In beginning use of the apparatus 10, a section of tubing 80 (e.g., a flexible polyvinylchloride (PVC) tubing) may be provided for placement within tube holding block 12. The tubing 80 has an end 82 and an outer circumferential surface 84 extending entirely along the length of tubing 80. In some embodiments, portions of outer circumferential surface 84 at or in proximity to end 82 are to be hermetically sealed and fixedly secured in a plastic fitting intended for medical applications. Adhesive is applied to the outer circumferential surface 84 of tubing 80 adjacent end 82 by loading end 82 of tubing 80 into the tube holding channel portions 38a, 38b of the adhesive block portion 14 and vacuum block portion 16, with the block portions 14, 16 brought from the load position to the dispense position upon introduction of the tubing 80. As previously described, with the tubing 80 positioned in tube holding block 12, the end 82 should be positioned within the tip holding portion 42 of the tube holding channel 38, with an opening 86 at the end 82 of tubing 80 ideally sealing against the conical channel end 44.

Upon placement of the tubing 80 within tube holding block 12 (with block portions 12, 14 in the dispense position), the vacuum source 24 is operated to create a negative pressure environment within the tube holding channel 38, and specifically within tip holding portion 42. With the negative pressure environment generated within the tube holding channel 38, air is caused to flow into the first air inflow channel 56 from the ambient environment—indicated at arrow 88—as the air pressure outside of tube holding block 12 is higher than the air pressure within the tube holding channel 38. In some embodiments, when the opening 86 at end 82 does not form an ideal seal against the conical channel end 44, air may also be caused to flow into the second air inflow channel 46 from the ambient environment—indicated at arrow 90—again due to the air pressure outside of tube holding block 12 being higher than the air pressure within the tube holding channel 38. The airflow that flows into first air inflow channel 56 (and, potentially, second air inflow channel 46) enters into the tip holding portion 42 and is subsequently drawn out of the tip holding portion 42 through vacuum opening 76, thereby creating an airflow through the tip holding portion 42.

While the vacuum source 24 is operating to create a pressurized airflow through the tip holding portion 42, a flow of liquid adhesive material is initiated by actuating valve 22 to permit adhesive to flow from the adhesive supply 20 into adhesive chamber 48 and adhesive flow path 50, as indicated at arrow 92. At this point, adhesive has entered adhesive flow path 50 and is mixed with air that is flowing into/through first air inflow channel 56 (via intersection of the first air inflow channel 56 with the adhesive flow path 50), thereby creating an air-adhesive mixture that is directed into the tip holding portion 42 of tube holding channel 38. The air-adhesive mixture flows into the tip holding portion 42 and circulates about the end 82 of tubing 80, as indicated at arrows 94, such that adhesive is caused to be deposited onto the outer circumferential surface 84 of tubing 80 at end 82. That is, with the gap provided within tip holding portion 42 (between walls thereof and the outer circumferential surface 84 of tubing 80), there is room for the air-adhesive mixture to circulate within the tip holding portion 42 and wrap around the outer circumferential surface 84 of tubing 80, such that an even coating of adhesive may be deposited thereon.

As the air-adhesive mixture circulates within the tip holding portion 42, the air-adhesive mixture is drawn toward and out through the vacuum opening 76—indicated at arrow 96—this due to the vacuum source 24 providing an airflow through the tip holding portion 42 and drawing air out from the tip holding portion 42 through vacuum opening 76. Thus, any excess adhesive in the air-adhesive mixture circulating within the tip holding portion 42 that is not applied onto the tubing 80 may be drawn out through the opening and removed from the tip holding portion 42. As shown in FIG. 6, the vacuum opening 76 is formed on a side of tip holding portion 42 that is generally opposite from the adhesive opening 56 formed in tip holding portion 42.

In embodiments where the end 82 of tubing 80 forms an ideal seal against the conical channel end 44, adhesive is prevented from entering into (and potentially clogging) the opening 86 formed in end 82 of tubing 80, despite the air-adhesive mixture circulating within the tip holding portion 42.

In embodiments where the end 82 of tubing 80 does not form an ideal seal against the conical channel end 44, adhesive is prevented from entering into (and potentially clogging) the opening 86 formed in end 82 of tubing 80 due to air that is flowing through the second air inflow channel 46 and into the conical channel end 44 and tip holding portion 42. That is, air that is drawn into first airflow channel 46 and flows through the conical channel end 44 and into tip holding portion 42 pushes the air-adhesive mixture away from the opening 86 at end 82 of tubing 80 and toward vacuum opening 76, to prevent adhesive from entering into the opening 86.

Upon completion of the adhesive coating of the end 82 of tubing 80, the actuator assembly 18 may be actuated again to move vacuum block portion 16 from the dispense position back to the load position. Tubing 80 is then removed from tube holding block 12 (and from apparatus 10 in general) and has a thin uniform coating of adhesive at the end 82 thereof.

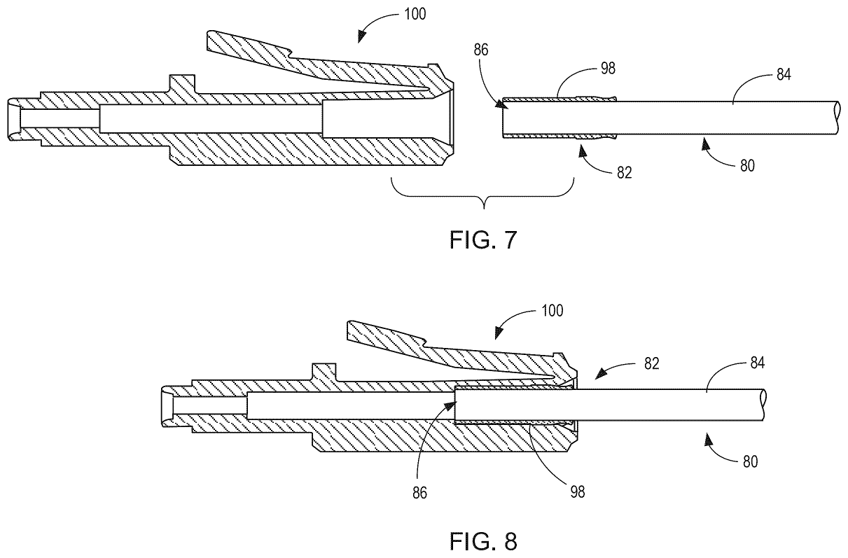

FIG. 7 illustrates tubing 80 with a thin uniform coating of adhesive 98 at the end 82 thereof, with no excess adhesive 98 being present within the opening 86.

As shown in FIG. 7 and FIG. 8, in some embodiments, the adhesive coated end 82 of tubing 80 may then be inserted into a fitting 100 and may be subjected to UV radiation for curing. Again, substantially no excess adhesive 98 exists either at the opening of fitting 100 or at end 82 of tubing 80. Hence, fluid flow through tubing 80 is not impeded and latches or other safety structures on fitting 100 are not affected by excess adhesive 96.

Beneficially, embodiments of the disclosure thus provide an apparatus and method for applying a liquid to an end section of the outer surface of a small diameter component, such as applying liquid adhesive to the end section of small diameter tubing. The apparatus including a holding block within which a negative pressure environment may be created via use of a vacuum. A tip holding portion within the holding block retains an end section of tubing therein, with an air-adhesive mixture dispensed into the tip holding portion and circulating about the end section of the tubing via an airflow present in the tip holding portion created by the negative pressure environment therein. The air-adhesive mixture deposits adhesive onto the end section while being prevented from adhesive entering into a tube opening of the end section, with excess adhesive exiting the tip holding portion through a vacuum opening.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. An apparatus for applying an adhesive to an outer circumferential surface of an end section of tubing, the apparatus comprising:
an adhesive supply configured to provide an adhesive;
a vacuum source configured to generate a vacuum;
a tube holding block in fluid communication with each of the adhesive supply and the vacuum source, the tube holding block comprising:
a tube holding channel including a tip holding portion and a channel end, with the tip holding portion and channel end retaining the end section of the tubing therein;
an adhesive flow path fluidly connected to the adhesive supply to receive adhesive therefrom and communicate adhesive to the tip holding portion through an adhesive opening formed in the tip holding portion;
a first air inflow channel extending between an exterior surface of the tube holding block and the adhesive flow path; and
a vacuum flow path fluidly connected to the vacuum source to communicate a vacuum to the tip holding portion through a vacuum opening formed in the tip holding portion, so as to create a negative pressure within the tip holding portion;
wherein the negative pressure within the tip holding portion draws air into the tube holding block through the first air inflow channel, with the air mixing with the adhesive in the adhesive flow path to inject an air-adhesive mixture into the tip holding portion that coats the end section with adhesive; and
wherein a portion of the air-adhesive mixture, including excess adhesive that does not coat the end section, is drawn out of the tip holding portion through the vacuum opening.

2. The apparatus of claim 1, wherein the tube holding block comprises an adhesive block portion and a vacuum block portion, wherein each of the adhesive block portion and the vacuum block portion includes a mirrored portion of the tube holding channel, with the mirrored portions joining together to form the tube holding channel, and wherein the adhesive block portion includes the adhesive flow path and the first air inflow channel therein and the vacuum block portion includes the vacuum flow path.

3. The apparatus of claim 2, further comprising an actuator assembly configured to move at least one of the adhesive block portion and the vacuum block portion, to bring the adhesive block portion and the vacuum block portion from a load position where the adhesive block portion is separated from the vacuum block portion to a dispense position where the adhesive block portion is joined with the vacuum block portion.

4. The apparatus of claim 2, wherein the vacuum block portion comprises engagement apertures formed therein via which the vacuum block portion is mounted to the actuator assembly.

5. The apparatus of claim 2, wherein the tube holding block comprises a second air inflow channel extending between an exterior surface of the tube holding block and the channel end, with each of the adhesive block portion and the vacuum block portion including a mirrored portion of the second air inflow channel and with the mirrored portions joining together to form second air inflow channel, and wherein the negative pressure within the tip holding portion draws air into the tube holding block through the second air inflow channel.

6. The apparatus of claim 5, wherein the air drawn into the tube holding block through the second air inflow channel prevents adhesive from entering into an opening formed in the end section of the tubing, by diverting the air-adhesive mixture away from the opening.

7. The apparatus of claim 5, wherein the first air inflow channel extends between a front surface of the tube holding block and the adhesive flow path and the second air inflow channel extends between the front surface of the tube holding block and the channel end.

8. The apparatus of claim 5, wherein the channel end comprises a conical channel end, the conical channel end tapering from a first diameter at an end thereof joined to the tip holding portion to a second diameter at an end thereof joined to the second air inflow channel, with the first diameter larger than a diameter of the tubing and the second diameter smaller than the diameter of the tubing.

9. The apparatus of claim 8, wherein the conical channel end is configured such that with end section of the tubing retained in the tip holding portion and conical channel end, the conical channel end forms a seal with an opening of the end section, so as to prevent adhesive from entering into the opening.

10. The apparatus of claim 2, wherein the vacuum block portion includes a protrusion configured to engage a cavity formed in the adhesive block portion, to secure the adhesive block portion with the vacuum block portion when in the dispense position.

11. The apparatus of claim 1, wherein the vacuum opening and the adhesive opening are formed on generally opposing sides of the tip holding portion, such that the air-adhesive mixture injected into the tip holding portion through the adhesive opening flows over and about the end section before exiting the tip holding portion through the vacuum opening.

12. The apparatus of claim 1, wherein a diameter of the tip holding portion is larger than a rear portion of the tube holding channel and larger than the end section of the tubing, such that a gap is present between walls of the tip holding portion and the end section.

13. The apparatus of claim 1, wherein a rear surface of the tube holding block comprises a funnel-shaped receptacle that forms a transition between the rear face and the tube holding channel.

14. The apparatus of claim 1, wherein the tube holding channel extends from a rear surface of the tube holding block to a location between the rear surface and a front surface of the tube holding block, such that the tube holding channel extends only partially through a length of the tube holding block.

15. A method for applying adhesive to an outer circumferential surface of an end section of tubing having an opening therein, the method comprising:
positioning a portion of the tubing into a tube holding channel of a tube holding block, including positioning the end section of the tubing into a tip holding portion and channel end of the tube holding channel;
creating a negative pressure condition in the tip holding portion via a vacuum source, the vacuum source in fluid communication with the tip holding portion through a vacuum flow path formed in the tube holding block;
providing a liquid adhesive to the tip holding portion via an adhesive supply, the adhesive supply in fluid communication with the tip holding portion through an adhesive flow path formed in the tube holding block; and
drawing an airflow into the tip holding portion via a first air intake channel formed in the tube holding block, with the airflow drawn into the first air intake channel responsive to the negative pressure;
wherein the first air intake channel is joined to the adhesive flow path, such that the airflow mixes with the liquid adhesive to form an air-adhesive mixture that flows into the tip holding portion to coat the outer circumferential surface of the end section of the tubing; and
wherein a portion of the air-adhesive mixture, including excess adhesive that does not coat the end section, is drawn out of the tip holding portion through the vacuum flow path.

16. The method of claim 15, further comprising drawing an airflow into the tip holding portion through the channel end via a second air intake channel formed in the tube holding block, with the airflow drawn into the second air intake channel responsive to the negative pressure.

17. The method of claim 16, wherein the airflow drawn into the tube holding block through the second air inflow channel prevents adhesive from entering into the opening in the end section of the tubing, by diverting the air-adhesive mixture away from the opening.

18. The method of claim 15, wherein positioning the end section of the tubing into the tip holding portion and channel end comprises engaging the end section with the channel end such that the opening of the end section forms a seal with the channel end, so as to prevent adhesive from entering into the opening.

19. The method of claim 15, wherein the air-adhesive mixture that flows into the tip holding portion flows through an adhesive opening formed on a first side of the tip holding portion and the air-adhesive mixture is drawn out of the tip holding portion through a vacuum opening formed on a second side of the tip holding portion that is generally opposite the first side, such that the air-adhesive mixture that flows into the tip holding portion through the adhesive opening flows over and about the end section before exiting the tip holding portion through the vacuum opening.

20. The method of claim 15, wherein the tube holding block comprises an adhesive block portion and a vacuum block portion, and wherein the method comprises operating an actuator assembly to move at least one of the adhesive block portion and the vacuum block portion, to bring the adhesive block portion and the vacuum block portion from a load position where the adhesive block portion is separated from the vacuum block portion to a dispense position where the adhesive block portion is joined with the vacuum block portion.
